(19) United States
(12) Patent Application Publication
(10) Pub. No.: US 2025/0091679 A1
(43) Pub. Date: Mar. 20, 2025

(54) VEHICLE

(71) Applicant: HONDA MOTOR CO., LTD., Tokyo (JP)

(72) Inventors: Masayuki Kinoshita, Tokyo (JP); Takuya Furuyama, Tokyo (JP); Keisuke Nakata, Tokyo (JP); Hitoshi Tsusaka, Tokyo (JP)

(21) Appl. No.: 18/885,778

(22) Filed: Sep. 16, 2024

(30) Foreign Application Priority Data
Sep. 19, 2023 (JP) 2023-151752

(51) Int. Cl. B62J 43/16; B62J 1/08; B62J 43/28; H01M 50/249; H01M 50/271

(52) U.S. Cl. CPC B62J 43/16; B62J 1/08; B62J 43/28; H01M 50/249; H01M 50/271; H01M 2220/20

(57) ABSTRACT

The electric motorcycle includes: a battery case mounted on a vehicle body frame; a seat that has a front portion disposed above the battery case and on which an occupant is seated; and a stay member that is fixed to the battery case and receives a load applied to the seat.

### CROSS-REFERENCE TO RELATED APPLICATION

Priority is claimed on Japanese Patent Application No. 2023-151752, filed in Japan on Sep. 19, 2023, the entire content of which is incorporated herein by reference.

### BACKGROUND OF THE INVENTION

### Field of the Invention

The present invention relates to a vehicle.

### Description of Related Art

In these years, efforts for realizing a low-carbon society or a decarbonized society are actively taken, and also for vehicles, research and development related to electrification techniques are conducted in order to reduce CO₂ emissions and improve energy efficiency.

For example, Patent Document 1 below discloses a structure including a battery plate that covers at least a part of an opening of a battery, in which a seat is engaged with the battery plate.
[Patent Document 1] Japanese Unexamined Patent Application, First Publication No. 2017-190069

### SUMMARY OF THE INVENTION

It is desired to provide a vehicle body structure that does not require a load receiving member from the vehicle body and can support a seat front end with increased safety.

An aspect according to the present invention has been made in view of the above problems, and an object of the present invention is to provide a vehicle body structure with improved safety capable of supporting a seat front end without requiring a load receiving member from the vehicle body.

In order to solve the above problem and achieve the object, the present invention employs the aspects described below.
(1) A vehicle according to one aspect of the present invention includes: a battery case mounted on a vehicle body; a seat that has a front portion disposed above the battery case and on which an occupant is seated; and a stay member that is fixed to the battery case and receives a load applied to the seat.

With this constitution, the battery case can receive a load of a seat front end via the stay member, and thus a load receiving member (dedicated member) from the vehicle body is not required. Therefore, it is possible to provide a vehicle body structure with improved safety capable of supporting the seat front end without requiring a load receiving member from the vehicle body.
(2) In the above aspect (1), the battery case may include an extension portion extending outward from a portion where the battery cell is disposed, and the stay member may be fixed to the extension portion.

With this constitution, since there is no battery cell around the portion to which the stay member is fixed, it is possible to suppress transmission of a load to the battery cell
(3) In the above aspect (1) or (2), the stay member may be fixed to a base portion of a protrusion portion of the battery case.

With this constitution, since the stay member is fixed to the base portion of the protrusion portion having high rigidity in the protrusion portion of the battery case, a load applied to the seat can be more stably received.
(4) In any one of the above aspects (1) to (3), a frame member extending in a front-rear direction and a cover member that is disposed above the battery case and in front of the stay member and abuts on the frame member may be further provided, in which the cover member may be fixed to the stay member.

With this constitution, a load that cannot be received by the battery case can be received by the frame member via the stay member and the cover member.
(5) In any one of the above aspects (1) to (4), the stay member may include a seat fixing portion to which the seat is fixed near a portion fixed to the battery case with respect to a center of the stay member.

With this constitution, the load on the stay member itself can be reduced by setting the portion to which the seat load is applied to the vicinity of the fixing portion of the battery case.
(6) In any one of the above aspects (1) to (5), the stay member may include a seat fixing portion to which the seat is fixed, and a wiring support portion configured to support a wiring, and the wiring support portion is disposed on an opposite side of the seat fixing portion with respect to a center of the stay member.

With this constitution, it is possible to suppress application of a load biased to one side with respect to the center of the stay member while integrating the functions of the seat fixing portion and the wiring support portion in the stay member.
(7) In any one of the above aspects (1) to (6), the battery case may include a strength member at a center in the vehicle width direction.

With this constitution, since the strength and rigidity of the battery case are enhanced, the seat load can be more effectively received.

According to an aspect of the present invention, it is possible to provide a vehicle body structure with improved safety capable of supporting the seat front end without requiring a load receiving member from the vehicle body.

### BRIEF DESCRIPTION OF THE DRAWINGS

FIG. 1 is a left side view of an electric motorcycle (saddle-type electric vehicle) according to an embodiment of the present invention;

FIG. 2 is a left side view of a substantial part of the above electric motorcycle;

FIG. 3 is a plan view (top view) of the substantial part of the above electric motorcycle;

FIG. 4 is a perspective view of a battery unit of the above electric motorcycle;

FIG. 5 is a left side view illustrating an inside of the above battery unit;

FIG. 6 is a plan view (top view) of a peripheral portion of a stay member of the above electric motorcycle;

FIG. 7 is a left side view of a peripheral portion of the above stay member;

FIG. 8 is a left side view including the above battery unit and the above stay member;

FIG. 9 is an enlarged left side view of the peripheral portion of the above stay member in FIG. 8;

FIG. 10 is a perspective view of a handle for attaching and detaching the above battery unit;

FIG. 11 is a plan view (top view) of a peripheral portion of the above handle; and

FIG. 12 is a left side view of the peripheral portion of the above handle.

### DETAILED DESCRIPTION OF THE INVENTION

Hereinafter, an embodiment of the present invention will be described with reference to the drawings. In the following description, directions of front, rear, upper, lower, left, and right are the same as directions in a vehicle to be described below. That is, an up-down direction coincides with a vertical direction, and a left-right direction coincides with a vehicle width direction. In the vehicle width direction, a direction away from the vehicle width center will be referred to as an outer side in the vehicle width direction, and a direction approaching the vehicle width center will be referred to as an inner side in the vehicle width direction. In the drawings to be used in the following description, an arrow UP indicates upward, an arrow FR indicates forward, and an arrow LH indicates leftward. A line CL in the drawings indicates a center line in the vehicle width direction (vehicle width center).

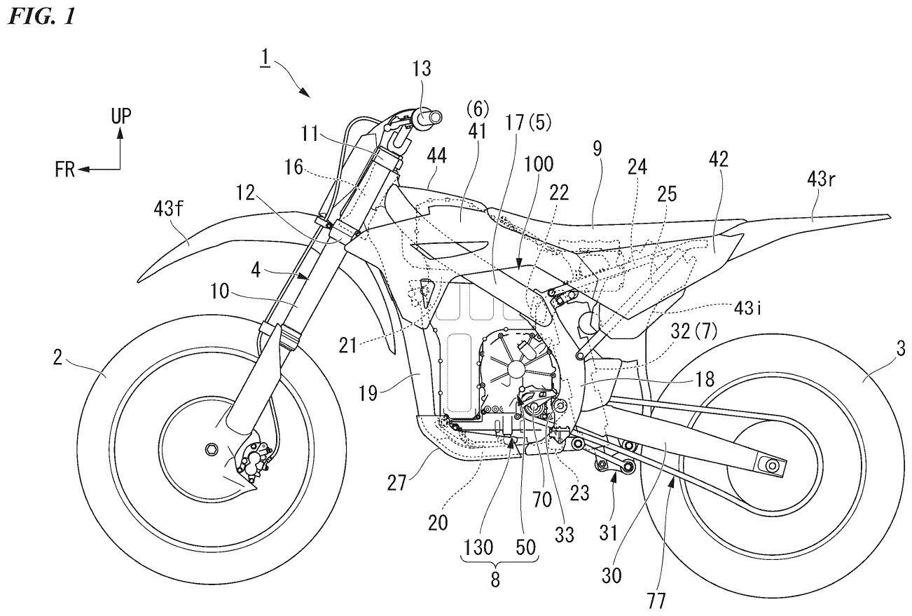

FIG. 1 is a left side view of an electric motorcycle (saddle-type electric vehicle) 1 according to one embodiment.

As illustrated in FIG. 1, the electric motorcycle 1 in one embodiment is a saddle-type electric vehicle of an off-load type. In the electric motorcycle 1, an up-down stroke amount of the wheel is largely ensured, a ground height of the vehicle body is largely ensured, and the vehicle body is downsized and light-weighted to concentrate the mass of the vehicle body.

The electric motorcycle 1 includes a front wheel 2, a rear wheel 3, a front wheel suspension system 4, a vehicle body frame 5, a vehicle body cover 6, a rear wheel suspension system 7, a power unit 8, and a battery unit 100.

The front wheel suspension system 4 includes: a pair of left and right front forks 10, which pivotally support the front wheel 2 at lower end portions; a top bridge 11 and a bottom bridge 12, which are provided between upper parts of the pair of front forks 10; and a stem pipe (not illustrated) provided between the top bridge 11 and the bottom bridge 12 and inserted into a head pipe 16. The front wheel 2 is supported to be steerable by the head pipe 16 of the vehicle body frame 5 via the front wheel suspension system 4. A steering handlebar 13 is supported on the top bridge 11. In the embodiment, the front forks 10 of a telescopic type are exemplified as a front suspension of the electric motorcycle 1, without being limited to this constitution. For example, the front suspension may be of another type such as a link type using a swing arm.

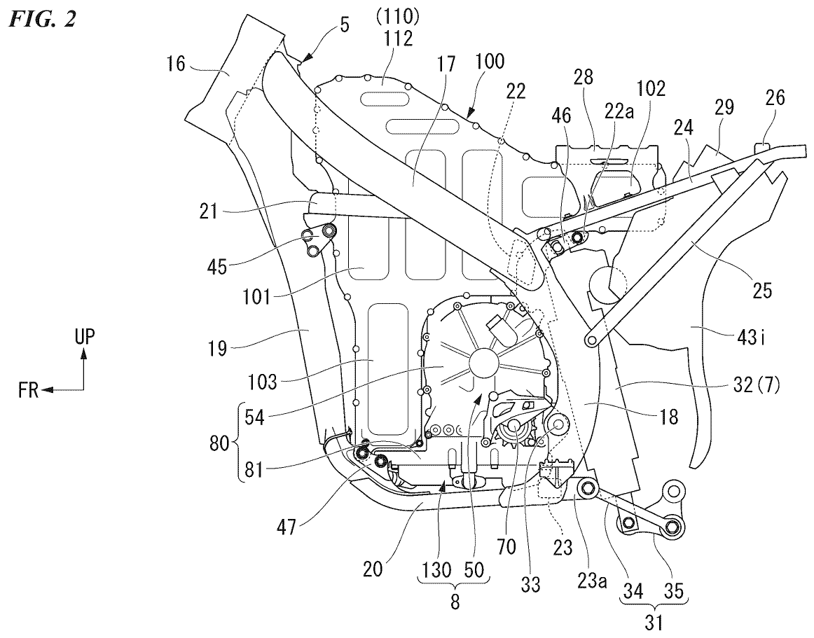

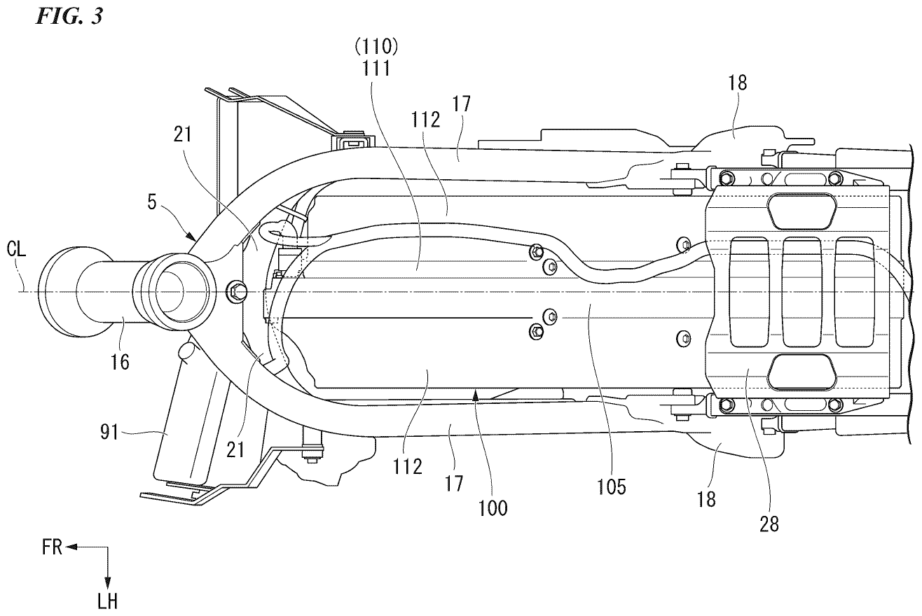

FIG. 2 is a left side view of a substantial part of the electric motorcycle 1, and FIG. 3 is a plan view (top view) of the substantial part of the electric motorcycle 1.

As illustrated in FIGS. 1 to 3, the vehicle body frame 5 includes the head pipe 16, a pair of left and right main frames 17, a pair of left and right pivot frames 18, a down frame 19 as a single part, a pair of left and right lower frames 20, a gusset pipe 21, which connects the left and right main frames 17 with the down frame 19, a cross member 22, and a lower cross member 23. They are integrally coupled by welding or the like. Hereinafter, an assembly in which these frame members are integrated not to be dividable will be referred to as a “frame main body”.

The head pipe 16 is positioned on a vehicle width center CL, and is provided as a single part on a front end of the vehicle body frame 5. The head pipe 16 is supported to be rotatable with the stem pipe inserted into the head pipe 16.

The pair of main frames 17 branch to the left and right from an upper portion of the head pipe 16, and extend rearward and downward. The pair of main frames 17 are coupled with each other in their respective front end portions. Front portions of the pair of main frames 17 extend while being curved to bulge outward in the vehicle width direction on a rear side of the head pipe 16, in a plan view when viewed from above. Rear portions of the pair of main frames 17 linearly extend along the front-rear direction, in the plan view when viewed from above.

The pair of pivot frames 18 extend rearward and downward respectively from rear end portions of the main frames 17 on the same left and right sides. The pair of pivot frames 18 are each curved, and extend to form an arc shape convex rearward in a side view. A pivot shaft 33, which extends in the vehicle width direction, is bridged between intermediate portions of the pair of pivot frames 18 on a lower side in the up-down direction. The term “intermediate” used in one embodiment includes not only the center between both ends of an object but also an inner range between both ends of the object.

The down frame 19 extends rearward and downward from a lower portion of the head pipe 16. The down frames 19 extend rearward and downward to be steeper than the main frames 17 in a side view. A radiator 91 for cooling the power unit 8 is attached to at least one of left and right side portions (a left side portion in one embodiment) of the down frame 19.

The pair of lower frames 20 branch to the left and the right from a lower end portion of the down frame 19, and extend rearward. Rear end portions of the pair of lower frames 20 are respectively coupled with lower end portions of the pivot frames 18 on the same left and right sides.

Left and right side portions of the gusset pipe 21 couple the main frames 17 with the down frames 19 on the same left and right sides. The gusset pipe 21 branches to the left and the right from an intermediate portion of the down frame 19 on an upper side in the up-down direction, and extend rearward. Rear end portions of the gusset pipe 21 are respectively coupled with intermediate portions in the front-rear direction of the main frames 17 on the same left and right sides.

The cross member 22 extends in the vehicle width direction, and couples rear portions of the pair of main frames 17 (or upper portions of the pair of pivot frames 18). A cushion support bracket 22a, which extends rearward and upward, are fixed on an inner side in the vehicle width direction of the cross member 22. An upper end portion of the rear cushion 32 and the battery unit 100 are coupled with the cushion support bracket 22a.

The lower cross member 23 extends in the vehicle width direction, and couples lower portions of the pair of pivot frames 18 on a lower side than the pivot shaft 33. A link support bracket 23a, which extends rearward, is fixedly provided on an inner side in the vehicle width direction of the lower cross member 23. A front end portion of a link arm 34 is coupled with the link support bracket 23a.

The vehicle body frame 5 further includes a pair of left and right seat rails 24, and a pair of left and right support rails 25. Front end portions of the left and right seat rails 24 are respectively coupled with upper end portions of the pivot frames 18 on the same left and right sides. Each of the left and right seat rails 24 extends rearward and upward from the front end portion. A seat 9 is disposed above the left and right seat rails 24. Front-rear intermediate portions of the left and right seat rails 24 are coupled with each other via a seat receiving bracket 28, which receives the load from the seat 9.

The left and right support rails 25 are positioned below the left and right seat rails 24. Front end portions of the left and right support rails 25 are respectively coupled with up-down intermediate portions of the pivot frames 18 on the same left and right sides. Each of the left and right support rails 25 extends rearward and upward from the front end portion. Rear end portions of the left and right support rails 25 are respectively coupled with the rear portions of the left and right seat rails 24 from below on the same left and right sides.

Rear portions of the left and right seat rails 24 are coupled with each other by a cross rail 26, which extends in the vehicle width direction. The pair of left and right seat rails 24, the pair of left and right support rails 25, and the cross rail 26 are integrally coupled by welding or the like. Hereinafter, an assembly in which these frame members are integrated not to be dividable will be referred to as a sub frame detachably attached to the frame main body. The sub frame corresponds to a seat frame that supports the seat 9 from below.

The vehicle body frame 5 is of a semi-double cradle type. In the vehicle body frame 5, the power unit 8 including a motor 50 is mounted below the rear portions of the left and right main frames 17 on a rear side of the head pipe 16 and on a front side of the left and right pivot frames 18. The vehicle body frame 5 surrounds the power unit 8 with the down frame 19 as a single part and the left and right lower frames 20 from the front side and the lower side.

Inside the vehicle body frame 5, the power unit 8 for the traveling of the vehicle is mounted, and in addition, the battery unit 100, which stores electric power to be supplied to the power unit 8, is mounted. The vehicle body frame 5 enables the battery unit 100 to be inserted and removed from above through an opening between the left and right main frames 17. Front portions of the left and right main frames 17 and the gusset pipe 21 each have a large curvature outward in the vehicle width direction in order to ensure a clearance with respect to the front portion of the battery unit 100.

The vehicle body cover 6 covers the vehicle body frame 5 and the like. The vehicle body cover 6 includes a pair of left and right front side cowls 41 and a pair of left and right rear side cowls 42.

The pair of front side cowls 41 are respectively disposed from lower positions on both left and right sides of the front portion of the seat 9 to positions that overlap an upper portion of the down frame 19, in a side view when viewed from the vehicle width direction. Each of the front side cowls 41 extends to be broader in a side view from below a front portion of the seat 9 toward the front side. The front side cowls 41 respectively extend in the front-rear direction to traverse the outside in the vehicle width direction of the main frames 17 on the same left and right sides. At least one of the front side cowls 41 functions as an air guide plate (radiator shroud) for the radiator 91, which is supported by a side portion of the down frame 19.

The pair of rear side cowls 42 are disposed in positions below the seat 9 on both left and right sides in a rear part of the seat 9 in a side view. The rear side cowls 42 are respectively disposed to cover the seat rail 24 and the support rail 25 on the same left and right sides from the outside in the vehicle width direction.

A rear fender 43r extends rearward on a rear side of the seat 9. The rear fender 43r is disposed above the rear wheel 3 to be spaced apart from the rear wheel 3. Reference number 43f in the drawing indicates a front fender disposed above the front wheel 2 to be spaced apart from the front wheel 2, and is supported by the bottom bridge 12. A top cover 44 is disposed on a front side of the seat 9 between upper end portions of front-rear intermediate portions of the pair of front side cowls 41. The top cover 44 covers an upper protrusion portion 110 of the battery unit 100 (see FIG. 2) from above.

The rear wheel suspension system 7 includes: a swing arm 30, which pivotally supports the rear wheel 3 at a rear end portion; a link mechanism 31, which couples a front portion of the swing arm 30 with the lower cross member 23; and a rear cushion 32, which extends between the link mechanism 31 and the cross member 22.

The swing arm 30 is disposed below a rear part of the vehicle body, and extends in the front-rear direction. A front end portion of the swing arm 30 is supported to be swingable up and down by the pair of pivot frames 18 via the pivot shaft 33.

The link mechanism 31 includes a pair of left and right link arms 34 and a link member 35. The pair of link arms 34 are disposed below a front portion of the swing arm 30 in a side view, and extends in the front-rear direction. A front end portion of the link arm 34 is rotatably coupled with the link support bracket 23a of the lower cross member 23 via a shaft along the vehicle width direction. A rear end portion of the link arm 34 is rotatably coupled with the link member 35 via a shaft along the vehicle width direction.

The link member 35 is formed in a substantially triangular shape in a side view. A top portion on an upper side of the link member 35 is rotatably coupled with a link coupling portion in a front-rear intermediate portion of the swing arm 30 via a shaft along the vehicle width direction. A top portion on a lower side of the link member 35 is rotatably coupled with a rear end portion of the link arm 34 via a shaft along the vehicle width direction. A top portion on a front side of the link member 35 is rotatably coupled with a lower end portion of the rear cushion 32 via a shaft along the vehicle width direction.

The rear cushion 32 is provided on an inner side in the vehicle width direction (for example, on the vehicle width center CL) in the rear part of the vehicle body. The rear cushion 32 is formed in a cylindrical shape in which a compression coil spring is disposed on the outer circumference of a damper cylinder, and is disposed in an attitude in which the axial direction is inclined forward with respect to the vertical direction. An upper end portion of the rear cushion 32 is rotatably coupled with the cushion support bracket 22a of the cross member 22 via a shaft along the vehicle width direction. A lower end portion of the rear cushion 32 is rotatably coupled with the top portion on the front side of the link member 35 via a shaft along the vehicle width direction. In the embodiment, a constitution in which the rear cushion 32 is provided as a single part on the inner side in the vehicle width direction is exemplified, without being limited to this constitution. For example, another constitution such as a constitution in which a pair of left and right rear cushions 32 are provided between a rear portion of the swing arm 30 and the seat frame may be employed.

The power unit 8 includes: the motor 50 for driving the vehicle; a speed reduction gear (not illustrated) that decelerates output of the motor 50; an output shaft 70, which outputs dynamic power of the motor 50 that has been decelerated by the speed reduction gear; a power control unit (PCU) 130 for controlling the motor 50; and a housing 80, which houses a drive unit, such as the motor 50 and the speed reduction gear, and the PCU 130.

The power unit 8 is constituted as an integrated unit including the motor 50, the speed reduction gear, the output shaft 70, the PCU 130, and the housing 80. The PCU 130 is disposed below the motor 50. The housing 80 forms an outer shape of the power unit 8. The power unit 8 can be cooled by a water-cooling system including the radiator 91.

The motor 50 is disposed with its rotation axis direction along the vehicle width direction. The motor 50 is housed in a motor case 54, which is formed in an upper part of the housing 80. The speed reduction gear of a gear type is disposed on one of the left and right sides of the motor 50.

The output shaft 70 is disposed in a rear lower portion of the motor case 54. The output shaft 70 extends in the vehicle width direction, and a left end portion protrudes to the outside of the housing 80. The left end portion of the output shaft 70 and the rear wheel 3 are interlocked via a chain-type transmission mechanism 77. This enables the output of the motor 50 to be transmitted to the rear wheel 3.

The PCU 130 is a control device including a power drive unit (PDU) that is a motor driver, an electric control unit (ECU) that controls the PDU, and the like. The PDU includes an inverter, and converts electric current supplied from the battery unit 100 from direct current into alternating current, and then supplies the converted current to the motor 50. The PCU 130 is housed in a PCU case 81 of the housing 80.

In addition to the motor case 54, the housing 80 includes the PCU case 81, which houses the PCU 130. The PCU case 81 is disposed below the motor case 54. The PCU case 81 houses the PCU 130 in its inside. The front portion of the PCU case 81 protrudes to a front side relative to a front end portion of the motor case 54.

The power unit 8 (housing 80) is supported by the vehicle body frame 5 via a plurality of fixing portions (including rubber mounts). The power unit 8 is disposed on a front side (on an inner circumferential side) of the pivot frame 18, which is curved in the arc shape convex rearward in a side view. The power unit 8 is disposed above the lower frame 20. The power unit 8 is disposed below a rear lower end portion of the main frame 17 in a side view.

In the power unit 8, an upper portion (the motor case 54) is disposed on a rear side of the down frame 19 to be spaced apart from the down frame 19, and a lower portion (the PCU case 81) extends to near a lower end portion of the down frame 19. A lower part of the PCU case 81 is covered with an undercover 27, which is attached to the lower frame 20.

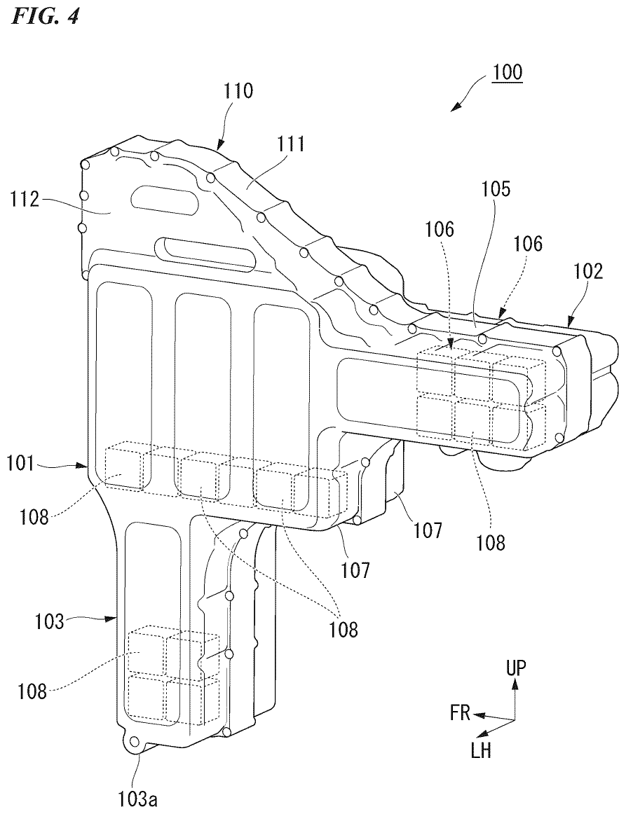

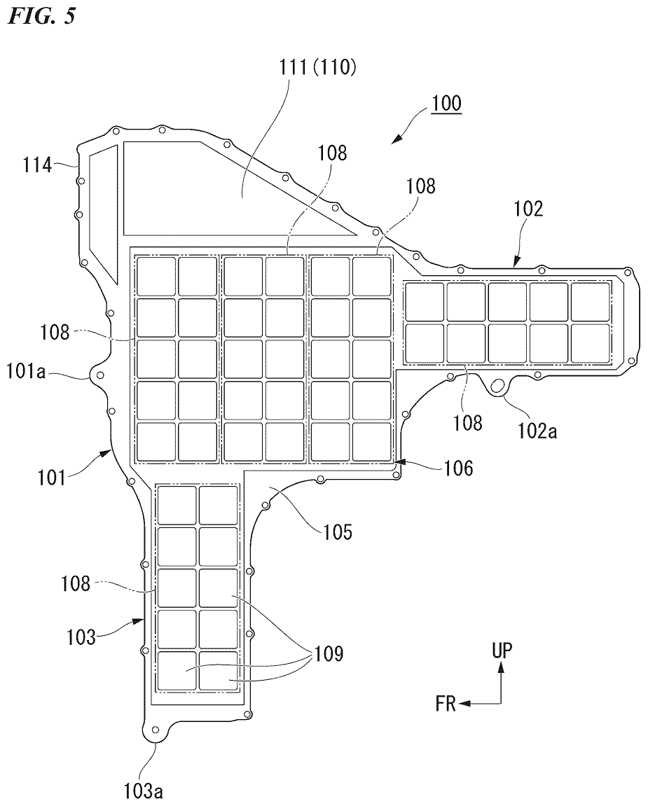

FIG. 4 is a perspective view of the battery unit 100, and FIG. 5 is a left side view illustrating the inside of the battery unit 100.

As illustrated in FIGS. 1 to 5, the battery unit 100 is formed in a substantially letter L shape in a side view, and is disposed from a front side to an upper side of the power unit 8. The battery unit 100 has a constant left-right width as a whole, and is disposed to be accommodated between inner side surfaces in the vehicle width direction of the left and right main frames 17 in a plan view. The battery unit 100 includes: a central portion 101, which has a substantially square shape in a side view, and which is disposed in a position that overlaps the main frame 17; a rearward extending portion 102, which extends rearward from a rear end of the central portion 101; and a downward extending portion 103, which extends downward from a lower end of the central portion 101.

The central portion 101 is disposed in such a manner that a rear upper portion protrudes above the main frames 17 and a front lower portion also protrudes below the main frames 17 in a side view. A portion, which protrudes upward from the main frame 17, of the central portion 101 is covered with a rear portion of the front side cowl 41 from an outer side in the vehicle width direction. On an outer side in the vehicle width direction of the central portion 101, the main frames 17 are disposed to traverse obliquely. A front end portion of the central portion 101 is supported on an up-down intermediate portion of the down frame 19 via a first mount bracket 45. Reference number 101a in the drawing indicates a first mount portion included in the front end portion of the central portion 101.

The rearward extending portion 102 extends rearward between an upper end portion of the rear cushion 32 and a lower surface of the seat 9 in the up-down direction. The rearward extending portion 102 extends rearward to a position that overlaps the front-rear intermediate portion of the seat rail 24 in a side view. The seat receiving bracket 28 is formed in a letter U shape to straddle the rearward extending portion 102 to the left and the right from above. A lower end portion of the rearward extending portion 102 is supported by the cross member 22 via a second mount bracket 46. The second mount bracket 46 is integrally formed with, for example, the cushion support bracket 22a. Reference number 102a in the drawing indicates a second mount portion included in the lower end portion of the rearward extending portion 102.

A 12 V battery 29 for auxiliary equipment is disposed on a further rear side of the rearward extending portion 102. The 12 V battery 29 is supported by a rear portion of the seat frame. Reference number 43i in the drawing indicates a rear inner fender that is supported by the support rail 25 and that suppresses scattering up by the rear wheel 3.

The downward extending portion 103 extends downward between a lower portion of the down frame 19 and the motor case 54 of the power unit 8 in the front-rear direction. The downward extending portion 103 extends to near an upper surface of the PCU case 81. A lower end portion of the downward extending portion 103 is supported by front end portions of the left and right lower frames 20 via a third mount bracket 47. Reference number 103a in the drawing indicates a third mount portion included in the lower end portion of the downward extending portion 103.

The battery unit 100 includes: a center plate 105, which is positioned on a vehicle width center CL; a pair of left and right battery assemblies 106, which are respectively disposed on the left and right sides of the center plate 105; and a pair of left and right battery covers 107, which respectively cover the left and right battery assemblies 106. The battery unit 100 is provided to be left-right symmetric as a whole with the vehicle width center CL as a symmetric axis. Provision of the battery unit 100, which is a heavy object, to be left-right symmetric suppresses the influence of the vehicle weight on the left-right balance.

Each battery assembly 106 is formed by combining a plurality of battery modules 108. Each battery module 108 has a substantially rectangular parallelepiped shape that is long in one direction, and is disposed with its length direction along the front-rear direction or the up-down direction. Each battery module 108 is formed by a plurality of battery cells 109 to be arranged vertically and horizontally. The respective battery cells 109 and battery modules 108 are disposed with their positions in the vehicle width direction aligned with each other.

Each battery module 108 has a thin and long outer shape in one direction, so that it can be easily disposed even in a small space. The shape of the battery unit 100 is easily formed to be suitable for an empty space of the vehicle body, by rearranging the arrangement of the plurality of battery modules 108 to change the overall outer shape. By increasing the degree of freedom in the shape of the battery unit 100, which is a heavy object, and increasing the degree of freedom in the arrangement in an empty space of the vehicle body, the influence on the center of gravity of the vehicle body can be suppressed.

The central portion 101 having a square shape in a side view is formed by, for example, disposing three battery modules 108 with their length directions oriented in the up-down direction and disposing the three battery modules 108 side by side in the front-rear direction. The rearward extending portion 102 having a rectangular shape in a side view is formed by disposing one battery module 108 with its length direction oriented in the front-rear direction. The downward extending portion 103 having a rectangular shape in a side view is formed by disposing one battery module 108 with its length direction oriented in the up-down direction.

In an upper end portion of the battery unit 100, the upper protrusion portion 110, which accommodates electric component parts such as contactors, is provided. The upper protrusion portion 110 protrudes upward relative to the main frame 17 in a side view, and is covered with the top cover 44 from above. The upper protrusion portion 110 includes a plate extension portion 111, in which an upper end portion of the center plate 105 is extended upward relative to upper ends of the battery assemblies 106. Electric component parts such as contactors are attached to both left and right sides of the plate extension portion 111. The upper end portions of the left and right battery covers 107 respectively include cover extension portions 112, which extend upward relative to the upper ends of the battery assemblies 106, so as to conform to the plate extension portion 111. The left and right cover extension portions 112 cover the plate extension portion 111 from the outside on the left and the right to suppress the electric component parts such as contactors from being exposed to the outside of the vehicle.

Rear portions of the plate extension portion 111 and the left and right cover extension portions 112 are positioned below the front portion, which is inclined upward, of the seat 9. Rear upper portions of the plate extension portion 111 and the left and right cover extension portions 112 are formed in a forward and upward inclined shape in a side view so as to conform to the inclination of the front portion of the seat 9. Outer side portions in the vehicle width direction of the left and right cover extension portions 112 are each formed in a chamfered shape that is inclined to be positioned downward toward the outer side in the vehicle width direction. This enables suppression of bulkiness of the upper protrusion portion 110, and the top cover 44 has a compact shape with roundness.

In a front end portion of the battery unit 100, a cable connection portion 114, which protrudes forward from the upper protrusion portion 110 and a front end portion on an upper side of the central portion 101. One end of a high-voltage cable (a positive electrode cable and a negative electrode cable) that extends from the PCU is connected with the cable connection portion 114, and one end of a low-voltage cable that extends from the 12 V battery 29 is also connected with the cable connection portion 114. A drive current is supplied from the battery unit 100 to the PCU 130 through the high-voltage cable, and a drive current is also supplied from the 12 V battery 29 to an electric component such as a contactor through the low-voltage cable.

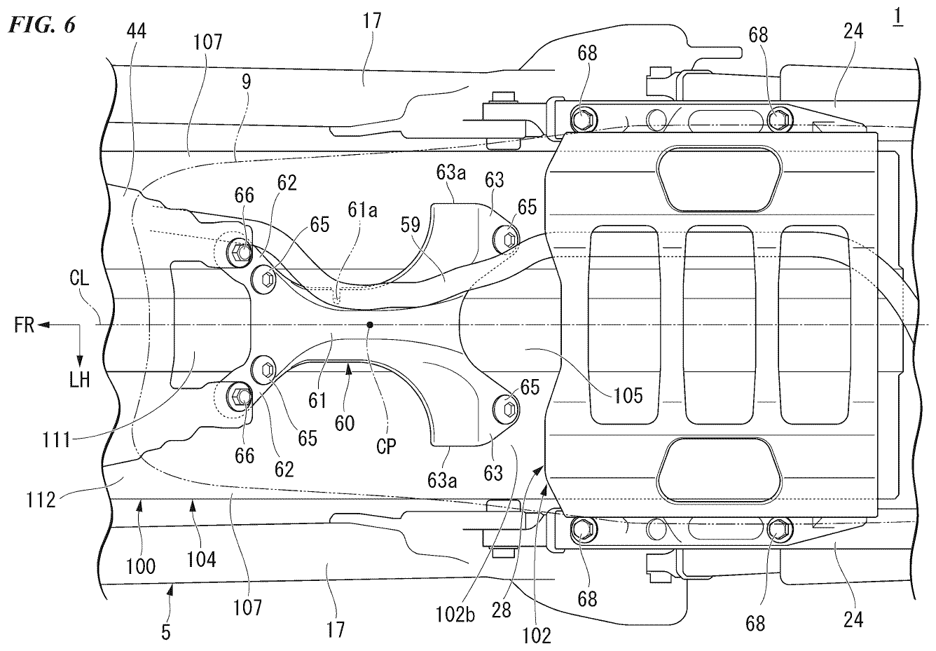

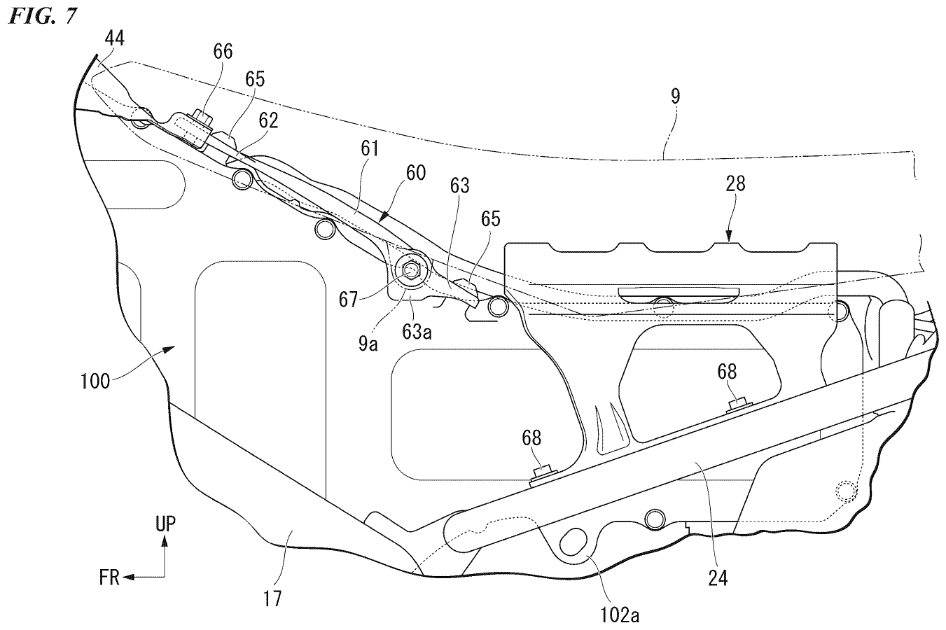

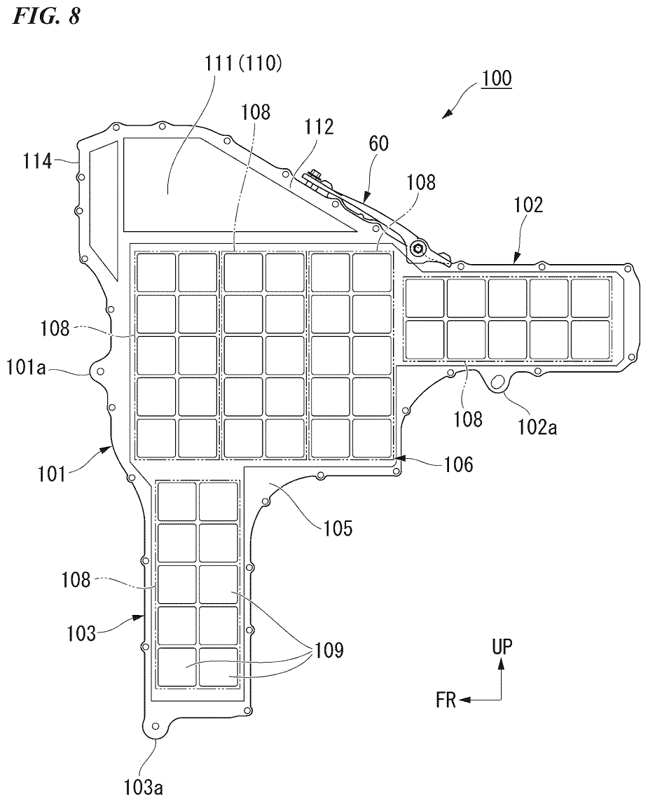

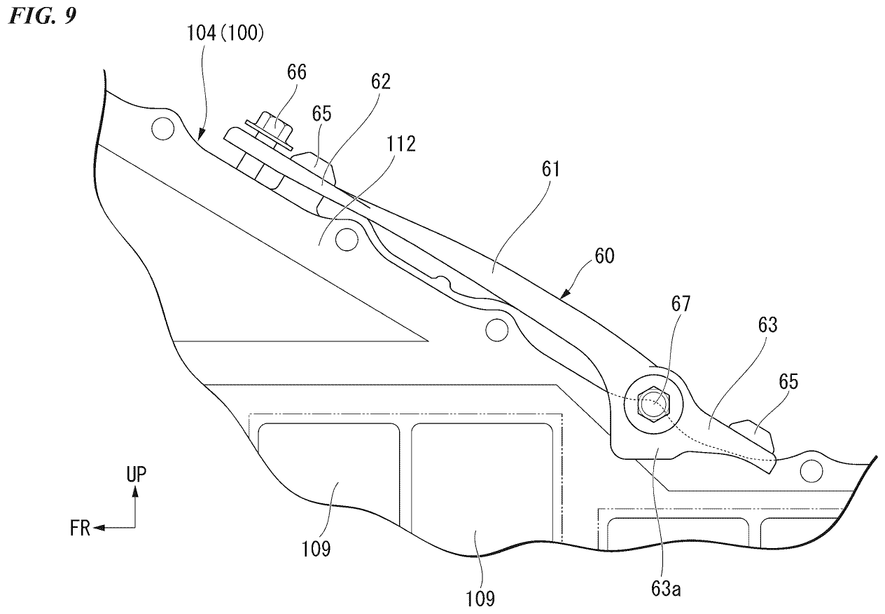

FIG. 6 is a plan view (top view) of a peripheral portion of the stay member 60 of the electric motorcycle 1. FIG. 7 is a left side view of a peripheral portion of the stay member 60. FIG. 8 is a left side view including the battery unit 100 and the stay member 60. FIG. 9 is an enlarged left side view of a peripheral portion of the stay member 60 in FIG. 8.

Referring also to FIGS. 6 to 9, the electric motorcycle 1 includes a battery case 104 mounted on a vehicle body frame 5 (corresponding to a vehicle body), the seat 9 that has a front portion disposed above the battery case 104 and on which an occupant is seated, and a stay member 60 that is fixed to the battery case 104 and receives a load applied to the seat 9.

The battery case 104 includes a pair of left and right battery covers 107. The battery case 104 is provided to be left-right symmetric as a whole with the vehicle width center CL as a symmetric axis. Thus, the influence of the vehicle weight on the left-right balance is suppressed.

A front end of the seat 9 is disposed in front of the stay member 60. The seat 9 is provided to be left-right symmetric as a whole with the vehicle width center CL as a symmetric axis. In the embodiment, the seat 9 is provided so that a portion close to the front end in a top view falls within a range in the vehicle width direction of the battery case 104.

The stay member 60 is disposed in front of the seat receiving bracket 28 that receives a load from the seat 9. The stay member 60 is formed in an X shape in a top view. The stay member 60 is provided to be left-right symmetric as a whole with the vehicle width center CL as a symmetric axis. The stay member 60 includes a center extending portion 61 extending in the front-rear direction in a top view, a front extending portion 62 branching to the left and right from a front portion of the center extending portion 61 and extending forward, and a rear extending portion 63 branching to the left and right from a rear portion of the center extending portion 61 and extending rearward.

The stay member 60 is fixed to a portion of the battery case 104 where the battery cell 109 is not disposed in the periphery (the cover extension portion 112 extending upward from the upper end of the battery assembly 106). In the embodiment, a front portion of the stay member 60 is fastened to an upper portion of the cover extension portion 112 at two left and right positions. The stay member 60 is fixed to a portion of the cover extension portion 112 that does not overlap the battery cell 109 in a side view (see FIG. 9).

For example, a bolt 65 is inserted into a through hole of the front extending portion 62 of the stay member 60 from above (specifically, obliquely rearward and upward) and screwed into a boss portion (female screw) on the upper portion of the cover extension portion 112. Thus, the left and right front extending portions 62 of the stay member 60 can be fastened to the upper portion of the cover extension portion 112.

The stay member 60 is fixed to a base portion 102b of the rearward extending portion 102 (an example of a protrusion portion) of the battery case 104. In the embodiment, a rear portion of the stay member 60 is fixed to an upper portion of the base portion 102b of the rearward extending portion 102 at two left and right positions.

For example, the bolt 65 is inserted into a through hole of the rear extending portion 63 of the stay member 60 from above (specifically, obliquely rearward and upward) and screwed into a boss portion (female screw) of the upper portion of the base portion 102b of the rearward extending portion 102. Thus, the left and right rear extending portions 63 of the stay member 60 can be fastened to the upper portion of the base portion 102b of the rearward extending portion 102.

In the embodiment, the stay member 60 is fastened to the battery case 104 at a total of four positions including two positions on the left and right of the front portion and two positions on the left and right of the rear portion. The stay member 60 is detachably attached to the battery case 104. In the embodiment, the attachment direction of the stay member 60 with respect to the battery case 104 (the insertion direction of the bolts) is the same in each part, which contributes to improvement of the attachment work.

The stay member 60 is not limited to the above, and may be fastened with five or more bolts. For example, the attachment mode (number and location of bolts, mounting direction, and the like) of the stay member 60 to the battery case 104 is not limited to the above, and can be changed according to design specifications.

The electric motorcycle 1 includes a main frame 17 (an example of a frame member) extending in the front-rear direction, and a top cover 44 (an example of a cover member) that is disposed above the battery case 104 and in front of the stay member 60 and abuts on the main frame 17. The top cover 44 is fixed to the stay member 60. In the embodiment, a rear portion of the top cover 44 is fastened to the front portion (specifically, near the front end) of the stay member 60 at two left and right positions.

For example, the bolt 66 is inserted into a through hole in the rear portion of the top cover 44 from above (specifically, obliquely rearward and upward) and screwed into a female screw portion (for example, a nut (not illustrated) provided on the lower surface side of the front extension portion 62) of the front extending portion 62 of the stay member 60. Thus, the rear portion of the top cover 44 can be fastened to the front extending portion 62 of the stay member 60.

In the embodiment, the top cover 44 is fastened to the stay member 60 at two rear portions. The stay member 60 is detachably attached to the top cover 44. In the embodiment, the attachment direction of the top cover 44 with respect to the stay member 60 (the insertion direction of the bolt) is the same in each part, which contributes to improvement of the attachment work. The attachment direction (bolt insertion direction) of the top cover 44 with respect to the stay member 60 is the same as the attachment direction (bolt insertion direction) of the stay member 60 with respect to the battery case 104, which contributes to further improvement of the attachment work.

The top cover 44 is not limited to the above, and may be fastened with three or more bolts. For example, the attachment mode (number and location of bolts, mounting direction, and the like) of the top cover 44 to the stay member 60 is not limited to the above, and can be changed according to the design specifications.

The stay member 60 includes a seat fixing portion 63a to which the seat 9 is fixed near the portion fixed to the battery case 104. In the embodiment, in the seat 9, the vicinity of the base portion 102b of the rearward extending portion 102 is fastened to the seat fixing portion 63a of the stay member 60 at two positions on the left and right. The seat fixing portion 63a is provided on left and right side wall portions of the rear extending portion 63 of the stay member 60.

For example, in the seat 9, a bolt 67 is inserted into a through hole (for example, a hole opening through the downward extending portion 9a of the seat 9 illustrated in FIG. 7 in the vehicle width direction) near the base portion 102b of the rearward extending portion 102 from the outside in the right-left direction, and is screwed into the seat fixing portion 63a (for example, a female screw) of the rear extending portion 63. Accordingly, in the seat 9, the vicinity of the base portion 102b of the rearward extending portion 102 can be fastened to the rear extending portion 63 of the stay member 60.

The stay member 60 includes the seat fixing portion 63a to which the seat 9 is fixed and a wiring support portion 61a configured to support a wiring 59. The wiring support portion 61a is disposed on the side opposite to the seat fixing portion 63a with respect to a center CP of the stay member 60. In the embodiment, the wiring support portion 61a is disposed on an opposite side (front side) of the seat fixing portion 63a with respect to the center CP of the stay member 60 in the front-rear direction and the left-right direction. The wiring support portion 61a is provided at a right edge portion of the center extending portion 61 of the stay member 60.

For example, a part of the wiring 59 extending in the front-rear direction is attached to the wiring support portion 61a of the center extending portion 61 via a fastening band (not illustrated). Thus, a part of the wiring 59 can be supported by the wiring support portion 61a. In the example of the drawing, the wiring 59 extends rightward and forward from the wiring support portion 61a and then extends to be curved forward in a top view. The wiring 59 extends rearward from the wiring support portion 61a in a top view, and then extends rearward through between the battery case 104 and the seat receiving bracket 28.

The battery case 104 includes a strength member 105 (corresponds to the center plate 105 located on the vehicle width center CL in the battery unit 100) at the center in the vehicle width direction. In the embodiment, the central portion of the stay member 60 overlaps the center plate 105 in a top view.

Referring also to FIG. 2, the cushion support bracket 22a extending rearward and upward is provided inside the cross member 22 in the vehicle width direction. An upper end portion of the rear cushion 32 is connected to the cushion support bracket 22a. In the battery unit 100, the lower end portion (second mount portion 102a) of the rearward extending portion 102 is supported by the cross member 22 via the second mount bracket 46. The second mount bracket 46 is integrally formed with, for example, the cushion support bracket 22a.

In the embodiment, since the cushion support bracket 22a is extended to support the battery unit 100, a dedicated member for supporting the battery unit 100 is not required. In the embodiment, the cushion support bracket 22a supports components other than the rear cushion 32. Therefore, the number of components is reduced to simplify the structure and contribute to cost reduction.

Referring also to FIGS. 6 and 7, the seat receiving bracket 28 extends so as to bridge between the left and right seat rails 24. The seat receiving bracket 28 is provided so as to straddle the rearward extending portion 102 of the battery unit 100 from the upper side to the left and right. The seat receiving bracket 28 is detachably attached to the left and right seat rails 24.

For example, bolts 68 are inserted into through holes in left and right side portions of the seat receiving bracket 28 from above (specifically, obliquely forward and upward) and screwed to the upper portions (female screws) of the left and right seat rails 24. Accordingly, the left and right side portions of the seat receiving bracket 28 can be fastened to the upper portions of the left and right seat rails 24.

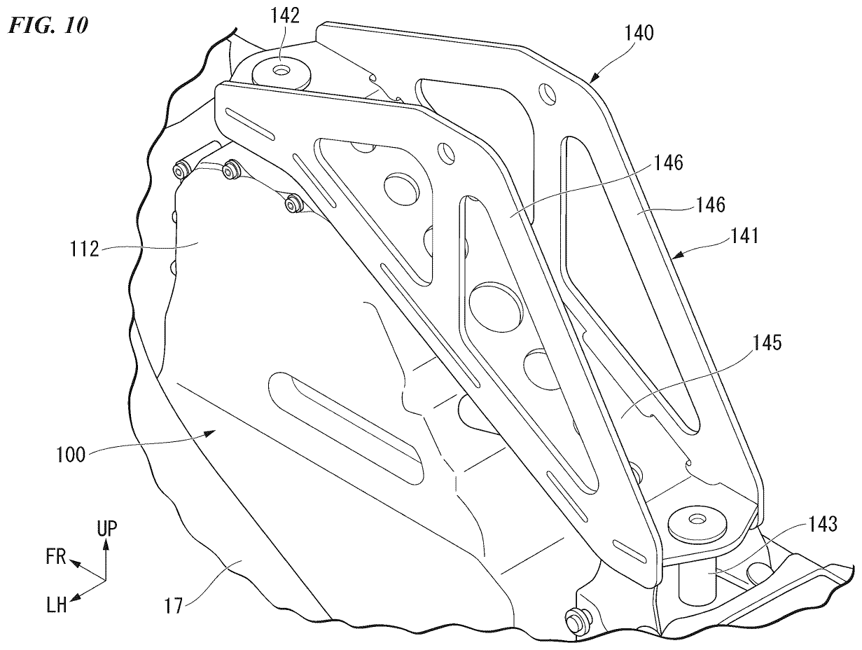

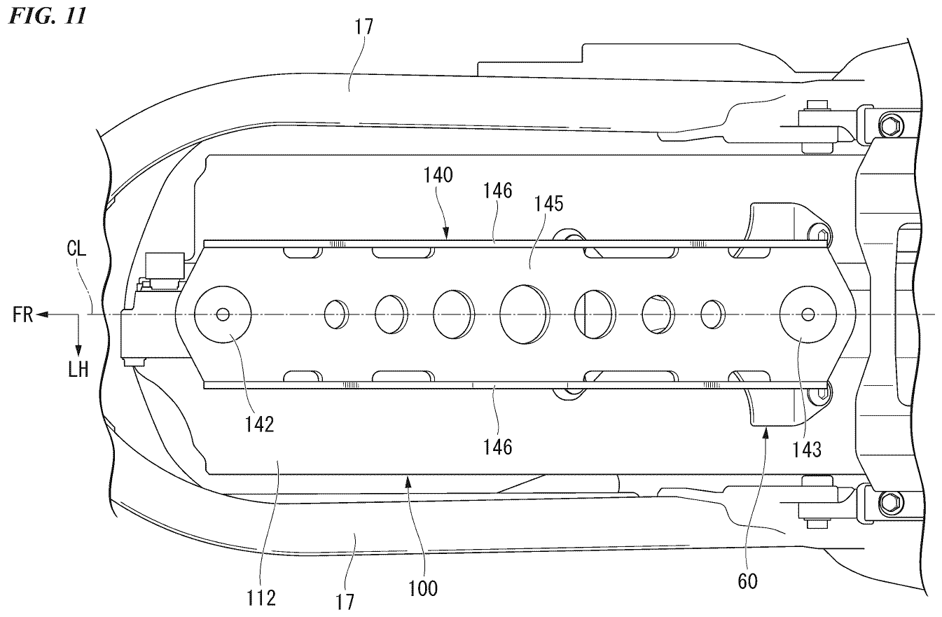

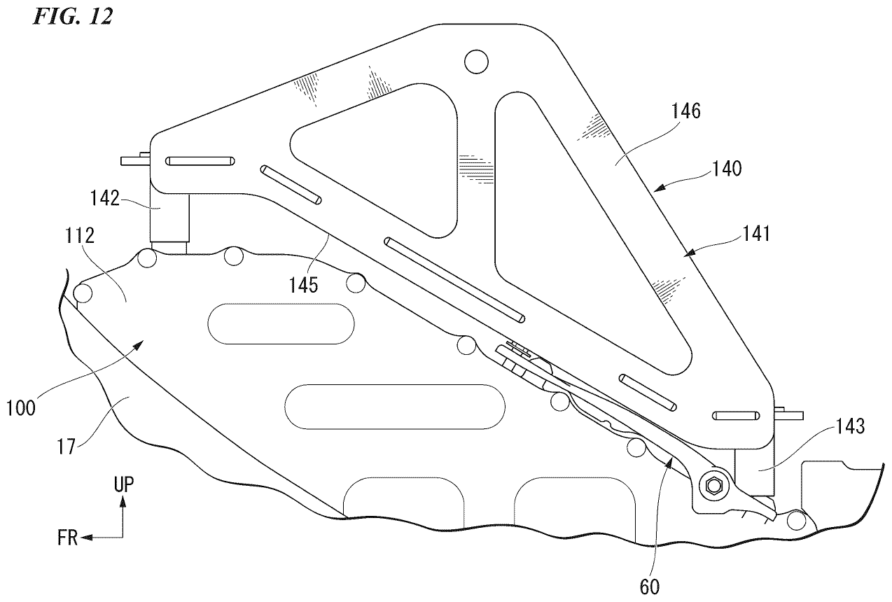

FIG. 10 is a perspective view of a handle 140 for attaching and detaching the battery unit 100. FIG. 11 is a plan view (top view) of a peripheral portion of the handle 140. FIG. 12 is a left side view of a peripheral portion of the handle 140.

With reference also to FIGS. 10 to 12, the handle 140 may be detachably provided on the battery unit 100.

The handle 140 is provided from near a front end to near a rear end of the cover extension portion 112 so as to straddle the stay member 60 in the front-rear direction. The handle 140 includes a handle main body 141 having a triangular shape protruding upward in a side view and a pair of front and rear attachment bosses 142 and 143.

The handle main body 141 includes a bottom plate portion 145 extending along an upper surface of the cover extension portion 112 in a side view, and a pair of left and right side plate portions 146 standing upward from left and right side portions of the bottom plate portion 145. A plurality of through holes may be formed in each of the bottom plate portion 145 and the side plate portions 146. Thus, the weight of the handle 140 is reduced, and the attachment and detachment work of the battery unit 100 is facilitated.

The pair of front and rear attachment bosses 142 and 143 include a front boss 142 extending downward from near a front end of the bottom plate portion 145 and a rear boss 143 extending downward from near a rear end of the bottom plate portion 145. For example, the front boss 142 is fastened to a receiving portion near an upper front end of the cover extension portion 112 with a bolt or the like, and the rear boss 143 is fastened to a receiving portion near an upper rear end of the cover extension portion 112 with a bolt or the like. Thus, the handle 140 can be fastened to the battery unit 100.

As described above, the electric motorcycle 1 according to the above embodiment includes the battery case 104 mounted on the vehicle body frame 5, the seat 9 that has the front portion disposed above the battery case 104 and on which the occupant is seated, and the stay member 60 that is fixed to the battery case 104 and receives a load applied to the seat 9.

With this constitution, the battery case 104 can receive a load of the seat 9 front end via the stay member 60, and thus a load receiving member (dedicated member) from the vehicle body is not required. Therefore, it is possible to provide a vehicle body structure with improved safety capable of supporting the front end of the seat 9 without requiring a load receiving member from the vehicle body.

In the above embodiment, the battery case 104 includes the extension portion 112 extending outward from the portion where the battery cell 109 is disposed. The stay member 60 is fixed to the extension portion 112.

With this constitution, since there is no battery cell 109 around the portion to which the stay member 60 is fixed, it is possible to suppress transmission of a load to the battery cell 109.

In the above embodiment, the stay member 60 is fixed to the base portion 102b of the rearward extending portion 102 of the battery case 104.

With this constitution, since the stay member 60 is fixed to the base portion 102b having high rigidity in the rearward extending portion 102 of the battery case 104, a load applied to the seat 9 can be more stably received.

In the above embodiment, the electric motorcycle 1 further includes the main frame 17 extending in the front-rear direction, and the cover member 44 that is disposed above the battery case 104 and in front of the stay member 60 and abuts on the main frame 17. The cover member 44 is fixed to the stay member 60.

With this constitution, a load that cannot be received by the battery case 104 can be received by the main frame 17 via the stay member 60 and the cover member 44.

In the above embodiment, the stay member 60 includes the seat fixing portion 63a to which the seat 9 is fixed near the portion fixed to the battery case 104 with respect to the center CP of the stay member 60.

With this constitution, the load on the stay member 60 itself can be reduced by setting the portion to which the seat load is applied to the vicinity of the fixing portion of the battery case 104.

In the above embodiment, the stay member 60 includes the seat fixing portion 63a to which the seat 9 is fixed and a wiring support portion 61a configured to support the wiring 59.

With this constitution, it is possible to suppress application of a load biased to one side with respect to the center CP of the stay member 60 while concentrating the functions of the seat fixing portion 63a and the wiring support portion 61a on the stay member 60.

In the above embodiment, the battery case 104 includes the strength member 105 at the center in the vehicle width direction.

With this constitution, since the strength and rigidity of the battery case 104 are enhanced, the load of the seat 9 can be more effectively received.

### Modifications

In the above embodiment, an example has been described in which the battery case includes the extension portion extending outward from the portion where the battery cell is disposed, and the stay member is fixed to the extension portion, without being limited to this constitution. For example, the battery case may not include the extension portion. For example, the stay member may be fixed to a portion of the battery case other than the extension portion (a portion where the battery cell is disposed in the periphery). For example, the fixing mode of the stay member with respect to the battery case can be changed according to the design specifications.

In the above embodiment, an example in which the stay member is fixed to the base portion of the protrusion portion of the battery case has been described, without being limited to this constitution. For example, the stay member may be fixed to a tip portion of the protrusion portion of the battery case. For example, the fixing mode of the stay member with respect to the protrusion portion of the battery case can be changed according to the design specifications.

In the above embodiment, an example has been described in which the vehicle further includes the frame member extending in the front-rear direction and the cover member that is disposed above the battery case and in front of the stay member and abuts on the frame member, in which the cover member is fixed to the stay member, without being limited to this constitution. For example, the cover member may be fixed to a member different from the stay member. For example, the fixing mode of the cover member can be changed according to the design specifications.

In the above embodiment, an example has been described in which the stay member includes the seat fixing portion to which the seat is fixed near the portion fixed to the battery case with respect to the center of the stay member, without being limited to this constitution. For example, the seat fixing portion may be provided at a portion far away from a portion where the stay member is fixed to the battery case. For example, the seat fixing portion may be provided in a member different from the stay member. For example, the installation mode of the seat fixing portion can be changed according to the design specifications.

In the above embodiment, an example has been described in which the stay member includes the seat fixing portion to which the seat is fixed and the wiring support portion configured to support the wiring, and the wiring support portion is disposed on the opposite side of the seat fixing portion with respect to the center of the stay member, without being limited to this constitution. For example, the wiring support portion may be disposed on the same side as the seat fixing portion with respect to the center of the stay member. For example, the arrangement mode of the wiring support portion can be changed according to the design specifications.

In the above embodiment, an example has been described in which the battery case includes the strength member at the center in the vehicle width direction, without being limited to this constitution. For example, the battery case may include a strength member outside in the vehicle width direction. For example, the battery case may not include the strength member. For example, the installation mode of the strength member can be changed according to design specifications.

In the above embodiment, an example has been described in which the power unit includes the motor for driving the vehicle (an example of the drive device) and the PCU for controlling the motor (an example of the control device), without being limited to this constitution. For example, the power unit may include an engine (an example of the drive device) and the ECU (an example of the control device) that controls the engine. For example, the constitution mode of the power unit (the modes of the drive device and the control device) can be changed in accordance with a design specification.

Note that the present invention is not limited to the above embodiments, and for example, the constitutions of the embodiments are not limited to be applied to a motorcycle of an off-load type, and may be applied to various saddle-riding type vehicles. Saddle-riding type vehicles include all vehicles in which a driver rides on the vehicle body, thus including not only motorcycles (including motorized bicycles and scooter-type vehicles) but also three-wheeled vehicles (including vehicles with two front wheels and one rear wheel as well as vehicles with one front wheel and two rear wheels) and four-wheeled vehicles (four-wheeled buggies and the like).

The constitution in the above embodiments is an example of the present invention, and various modifications can be made without departing from the gist of the present invention, such as replacing a component element in an embodiment with a known component element.

What is claimed is:

1. A vehicle comprising:
a battery case mounted on a vehicle body;
a seat that has a front portion disposed above the battery case and on which an occupant is seated; and
a stay member that is fixed to the battery case and receives a load applied to the seat.

2. The vehicle according to claim 1, wherein
the battery case includes an extension portion extending outward from a portion where the battery cell is disposed, and
the stay member is fixed to the extension portion.

3. The vehicle according to claim 1, wherein
the stay member is fixed to a base portion of a protrusion portion of the battery case.

4. The vehicle according to claim 1, further comprising:
a frame member extending in a front-rear direction; and
a cover member that is disposed above the battery case and in front of the stay member and abuts on the frame member, wherein
the cover member is fixed to the stay member.

5. The vehicle according to claim 1, wherein
the stay member includes a seat fixing portion to which the seat is fixed near a portion fixed to the battery case with respect to a center of the stay member.

6. The vehicle according to claim 1, wherein
the stay member includes
a seat fixing portion to which the seat is fixed, and
a wiring support portion configured to support a wiring, and
the wiring support portion is disposed on an opposite side of the seat fixing portion with respect to a center of the stay member.

7. The vehicle according to claim 1, wherein
the battery case includes a strength member at a center in the vehicle width direction.
